(19) United States
(12) Patent Application Publication
(10) Pub. No.: US 2019/0178435 A1
(43) Pub. Date: Jun. 13, 2019

(54) SEISMIC LEVELLING APPARATUS WITH PARTLY BALL-SHAPED TOP- AND BOTTOM NUT AND USE THEREOF

(71) Applicant: NGI A/S, Nørresundby (DK)

(72) Inventor: Tomas Hecht OLSEN, Klarup (DK)

(73) Assignee: NGI A/S, Nørresundby (DK)

(21) Appl. No.: 16/324,650

(22) PCT Filed: Aug. 21, 2017
(86) PCT No.: PCT/DK2017/050268

§ 371 Date: Feb. 11, 2019

(30) Foreign Application Priority Data
Aug. 31, 2016 (DK) PA 2016 70664
Feb. 20, 2017 (DK) PA 2017 70114

(51) Int. Cl. F16M 7/00

(52) U.S. Cl. CPC F16M 7/00; F16M 2200/08

(57) ABSTRACT

A levelling apparatus includes a column which can be mounted in a device such as a machine at an upper end and which is mounted in a foot at a lower end, the levelling apparatus further being provided with a fastening means that by tightening can lock the position of the column in relation to the foot. The lower end of the column is inserted into the foot and fastened thereto by tightening of a bottom nut whose upper end has a shape that is complementary to the contact surface of the foot that the bottom nut will touch by tightening. Furthermore, the levelling apparatus can be used in areas with high risk of earthquakes.

The invention relates to a levelling apparatus that comprises a column which can be mounted in a device such as a machine at an upper end, and which is mounted in a foot at a lower end, said levelling apparatus further being provided with a fastening means that by tightening can lock the position of the column in relation to the foot.

Furthermore, the invention relates to the use of the levelling apparatus.

There is from PCT/DK2014/050288 known a levelling apparatus that can be used for supporting machines in earthquake prone areas.

The machine foot that is known from PCT/DK2014/050288 is characterized by that the column is fastened to the foot with a bolt that is mounted from the lower side of the foot and fastens the column by fastening in an internal thread with which the column is provided, and which faces the foot.

From US 20130313385 A1 is known a machine foot in which a column is fastened into a foot and fixed herein. This known machine foot has a top nut and a bottom nut that can be fastened onto the foot.

However, there are some drawbacks in relation to the state of the art according to PCT/DK2014/050288, for instance that the internal threaded bore which is provided in the column, and which is used for screwing of the fastening bolt will reduce the ability of the column to resist applied forces. According to the state of the art, the column has an external contact part in the form of an outward flange over the foot and an external top nut that is located between the flange and the foot, so that a pressure from the column is transmitted to the foot via the flange and the top nut, and pulling forces between the foot and the column are transmitted via the fastening bolt.

Therefore, it is an object of the present invention to offer a technique without the above mentioned drawbacks. It is a further object to offer an alternative technique.

The object of the invention is achieved by means of a levelling apparatus of the type mentioned in the preamble of claim 1, where the thread around the lower end of the column is lead up over the foot, said thread is coupled to a top nut provided with internal thread, which top nut has a flange that extends out from the lower edge of its internal thread, said flange having a contact surface that is shaped as a part of a spherical shell and is adapted to come into contact with a corresponding external contact surface that is shaped as a part of a spherical shell on the upper side of the foot around an opening that the lower end of the column is lead through. Here, a spherical shell is supposed to mean a surface that in accordance with the production methods used is as close as possible to a spherical surface. In this way, the top nut will function as a fastening means so that fastening of the bottom nut and the top nut is provided by adjustment of the top nut. The top nut transmits pressure force to the foot by means of its downward facing contact surface, and via the extension of the column down through a bore in the top of the foot and the contact surface of the bottom nut towards the internal side of the foot is it possible to transmit pulling forces to the foot equivalent to the total load bearing capacity of the column, as the column is lead into the foot without any substantial reduction in diameter. This is of major importance in areas with earthquakes, where there is a risk of precision equipment being thrown into the air as a result of vigorous movements of the subsurface, if fastenings as such are not used on the subsurface, which will also resist large pulling forces. Through the fact that the column can be lead down into the foot with full diameter is it possible to use the total load bearing capacity of the column, also when it comes to pulling force in a direction upwards along the foot.

As stated in claim 2, it is a further characteristic of the invention that the upper end of the bottom nut is partly shaped as a spherical shell.

In this way, the column can for example be moved in relation to the foot. Thereby the coupling of the column to the foot is in the form of a ball joint, and as a result of the fact that the opening in the foot has a slightly larger diameter than the external diameter of the lower threaded piece of the column, a mobility arises, so that the column will be able to tilt or rotate around any lateral axis through the centre of the joint parts that are partly spherical: the upper side of the foot around the opening and the lower side of the top nut as well as the internal surface of the foot around the opening and the upper side of the bottom nut. It is presupposed that the partly spherical joint parts all are located in such a way that they have a common geometrical centre.

As stated in claim 3, the bottom nut is provided with a through threaded bore, so that the bottom nut can be mounted simply on the lower part of the column by means of the external thread thereof. hereby is it possible to adjust the distance between the bottom nut and the top nut both via the lower side of the foot and via the external surface of the top nut which to this means can be provided with engagement means, for instance in the form of couples of flat parallel opposite external surfaces.

As stated in claim 4, it is furthermore preferred that the lower end of the bottom nut is flat, so that the bottom nut has no parts that extend down under the lower end of the column, when the bottom nut is mounted thereon with full threaded engagement.

The height of the bottom nut is to be kept at a minimum, however, it must be ensured that there is sufficient material between the internal thread of the bottom nut and its shell shaped contact surface against the inner side of the foot to transmit the pulling forces that occur when the column carries its maximum weight in an earthquake prone area. This holds true no matter the turning or tilting angle that the column has in relation to the foot.

As stated in claim 5, it is advantageous if the bottom nut is provided with fastening means as well as fixing means. Fastening means means engagement surfaces which make it possible that the bottom nut can be exposed to an external torque from a tool that has engagement means corresponding to the fastening means of the bottom nut. For instance, this can be 2, 3 or more bores that are provided in the surface of the bottom nut that faces the surroundings, which allows a tool with a torque arm and an engagement part that conforms to the bores, to tighten the bottom nut with a suitable torque, so that the material of the foot between the bottom nut and the top nut is clamped between them. There should also be a through threaded bore from the lower side of the bottom nut to its internal threaded surface, so that a set screw can avoid that the bottom nut as a result of tremors releases itself from a fixed position.

If the levelling apparatus must be used in areas where there are special requirements concerning hygiene, the apparatus must be equipped with seals, so that there are no cracks and crevices that can be invaded by bacterial or grime coatings. For instance the top nut must have seals against the foot as well as against the column. Other components, such as the shown sleeve for protecting the upper thread must comprise seals in contact with the machine as well as in contact with the smooth part of the column under the upper threaded piece. Furthermore, also possible screws or bolts for fastening into the subsurface must be provided with seals between bolt heads and the upper side of the foot.

As stated in claim 6, the column must be inserted in the foot via an opening herein, where said opening comprises a domed part that is designed to enclose the bottom nut. The domed part is here surrounded by a flange with an upper side and a lower side, where the lower side extends along a plane, said plane stays uninterrupted by the bottom nut and the column regardless of the angular position of the column in relation to the foot. Furthermore, there are provided through openings in the flange between the upper side and the lower side for mounting of the foot onto a subsurface. These measures together ensure that the foot and thus the column can be mounted safely against a subsurface and that the column hereafter can be tilted to a suitable angular position in relation the plane of the subsurface without colliding with a bottom plate that is located along the plane.

As previously stated, the invention also pertains to the use of the levelling apparatus for areas with a high risk of violent vibrations such as earthquakes. The use here allows for keeping machines from moving around or be thrown into the air from the subsurface during an earthquake.

The invention will be explained in further detail referring to the drawings, in which:

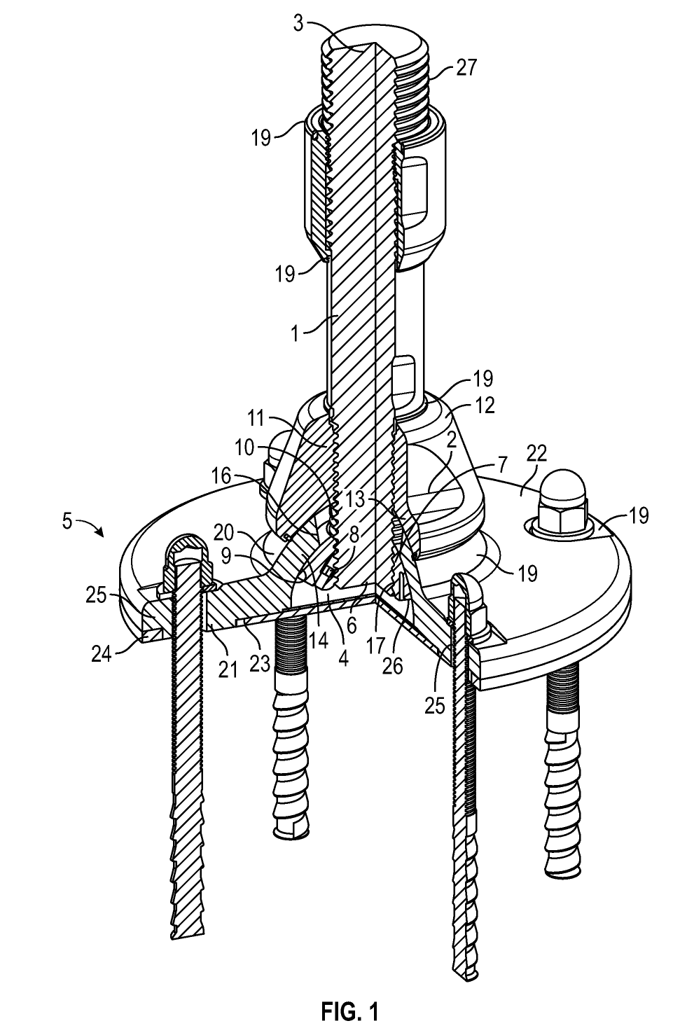

FIG. 1 shows a partly cut view of a levelling apparatus with a device for fixation of a column 1 and a foot 5, where the column 1 is fixed to the foot 5 using a partly ball-shaped bottom nut 4,

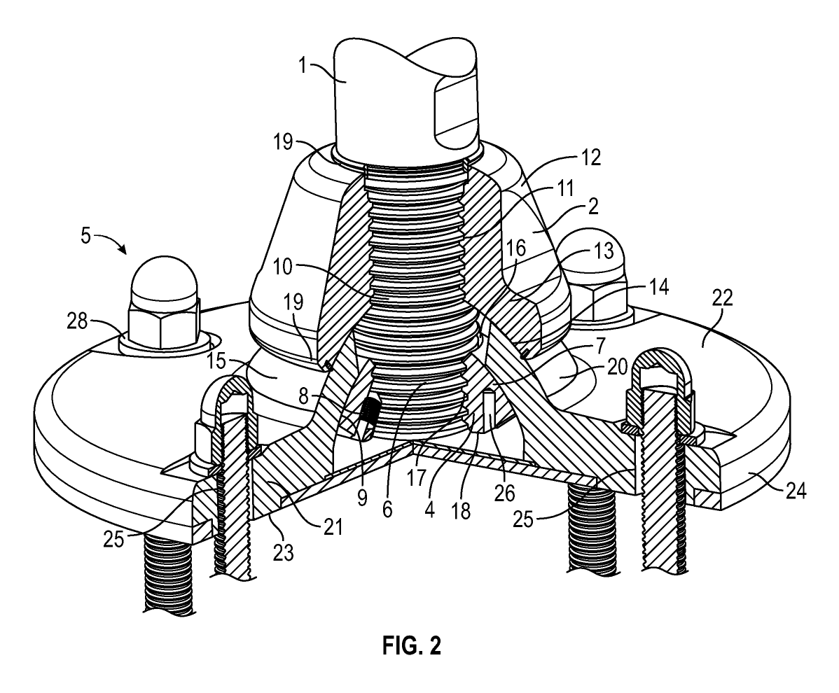

FIG. 2 shows an enlarged part view of FIG. 1,

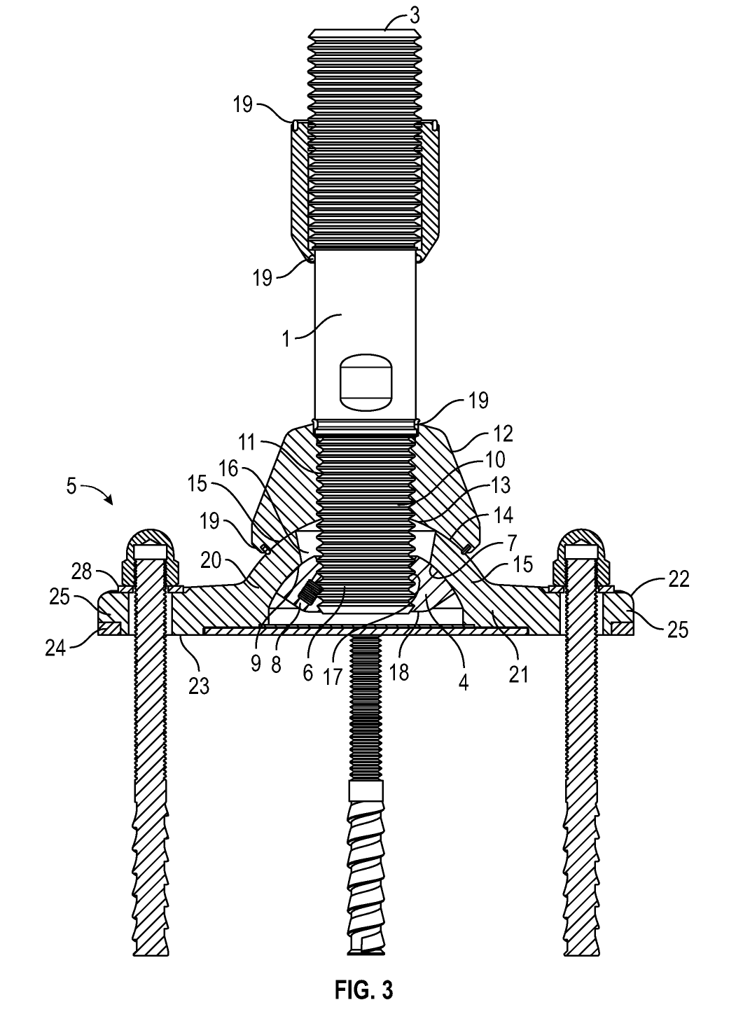

FIG. 3 shows a cut view of a levelling apparatus equipped with a partly ball-shaped bottom nut 4 that can be locked onto the column with a set screw 8, and

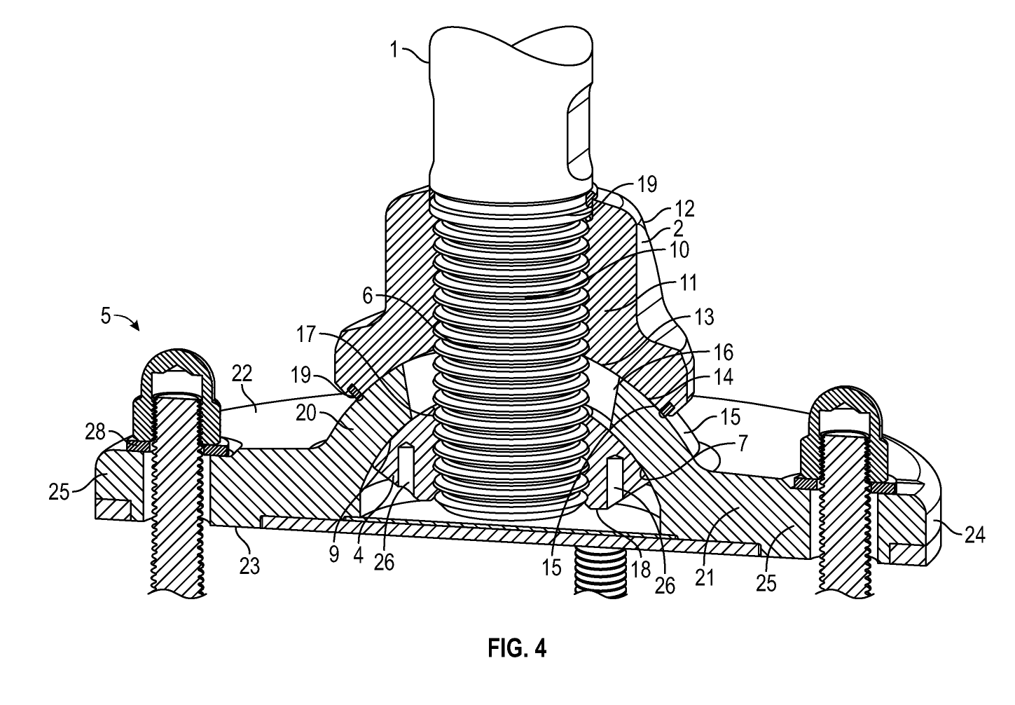

FIG. 4 shows an enlarged sectional view of an embodiment according to the invention,

In FIGS. 1-4 there is shown a levelling apparatus comprising a column 1 that in the upper end 3 is provided with a thread 27 for fastening in for example a machine so that the levelling apparatus can function as a machine foot. The column 1 passes at its lower end 6 through an opening 16 and down into the foot 5. The column is fastened to the foot 4 by using a specially designed bottom nut 7 that at its upper end 7 is shaped so that the surface has a shape which is complementary to the contact surface 9 that the bottom nut will touch as its counterpart, so that the upper surface 7 of the bottom nut in the example shown is shaped as a part of a ball-shaped shell or a spherical surface. The counterpart 9 of the bottom nut 4 is an internal surface of the foot 5, which also is shaped as a part of a spherical surface.

The ball-shaped shell surface of the spherical surfaces on the upper end 7 of the bottom nut 4 and the counterpart 9 that form the inner side of the foot 5 have the same radius and can therefor obtain a large mutual contact area which is useful for transmission of a large force.

As can be seen from the figures, it is a part of the invention that:

The levelling apparatus comprises a column 1 that at its upper end 3 can be mounted to a component such as a machine, and that it is mounted in a foot at its lower end 6, where the levelling apparatus furthermore is provided with a fastening device 2 comprising a top nut that, by fastening, can lock the position of the column 1 in relation to the foot 4, where the lower end 6 of the column is passed down into the foot 4 and fixed thereto by fastening of a bottom nut 4 which at an upper end 7 is complementary in shape to the contact surface 9 of the foot 5 that the bottom nut 4 will touch during fastening.

Furthermore, it is a special feature of the invention that:
The upper end of the bottom nut 4 is partly ball-shaped. This means that there in the area around the through opening of the bottom nut is a surface that is spherical or shaped as a ball-shell. The spherical surface is delimited in an upwards direction by the through opening and in the downwards direction by the outer rim of the bottom nut. Both delimitations are constituted by plane surfaces that are parallel with the same equatorial plane of the spherical surface. This common equatorial plane forms a right angle with the centre axis of the thread of the bottom nut.
The bottom nut 4 is provided with a through threaded bore 17 and the thread of the threaded bore matches the external thread on the lower part of the column 1 so that the bottom nut 4 can be mounted thereon.
The lower end 18 of the bottom nut 4 forms a flat surface, as can be seen in FIGS. 2, 3 and 4. The intersection between the lower end 18 and the bottom nut and its outer surfaces can be more or less chamfered or a facet can be provided, so that the transition between the lower flat end of the bottom nut and the side surfaces is via a surface with a conical design. In one embodiment, the spherical upper surface 7 extends all the way down to form an intersection with the conical element. This is to ensure that when the column 1 is tilted or tipped in relation to the foot, the transition between the lower plane end of the bottom nut and its side surfaces will not bump into a bottom plate that covers the foot in a downwards direction. As can be seen in the figures, the downwardly pointing flat surface on the bottom nut will, under these circumstances, be constituted by a delimited ring-shaped area around the through threaded bore of the bottom nut.
The height of the bottom nut is to be kept at a minimum. This means that the bottom nut and its threaded engagement with the column are designed to resist a pulling force that does not exceed the maximum permissible pulling force in the column.
The bottom nut 4 is provided with fastening means 26 such as engagement bores for mounting of the bottom nut and for fixing thereof by means of a set screw 8. The bottom nut must be tightened while it is surrounded by the foot, and therefor there is limited space around it for instance for engagement with a key or wrench that engages flats on a possible radially extending surface. Instead, two or more engagement bores 26 are provided in the lower end of the bottom nut. In this way, a key or wrench can be provided with prongs that mate with the bores so that the bottom nut can be tightened when the prongs are inserted in the engagement holes. I one embodiment, the holes simply situated on the conical part. It is furthermore necessary to keep the bottom nut from unintentional loosening, which could happen in connection with violent vibrations in the machine parts that carry the column or in connection with earthquakes. To avoid unintentional loosening a through threaded bore is provided from the lower end and up to the inner threaded bore of the bottom nut, so that it is possible to mount a set screw 8 in the through threaded bore, as is shown in FIGS. 1, 2 and 3. By tightening of such a set screw against the lower thread of the column, the bottom nut will be fastened towards this and will not come loose until the set screw is untightened again.
The levelling apparatus is provided with means such as seals 19 that are suitable for use in connection with high hygienic demands. The seals 19 are located at the transition between the column and the top nut 12 and between the domed part and the top nut 12. Furthermore, seals 18 will be provided between all heads of the screws or nuts that are lead through the outwardly extending flange of the foot for fixing onto the subsurface, and the upper side of the flange.
As can be seen in the Figures, the thread 10 around the lower end of the column fits the internal thread of the bottom nut 4. The outwardly extending flange of the top nut 12 has a downward contact surface 14, and as shown this surface fits a countersurface 15 on the central domed par 20 of the foot. The lower end 18 of the bottom nut 4 is shaped as a plane surface that can vary in size.

The foot 5 itself has, as an extension of the domed part 20, a flange 21 that extends out radially and has an upper surface 22 and a lower surface 23 as well as an outer rim 24. Inside of the outer rim the flange has through openings 25 with fastening means mounted therein and extending down into the subsurface for providing a means of fixation between the foot and the subsurface. It should be noted that the lower side of the flange in the central area under the column comprises a bottom plate, and that the upper surface thereof remains unaffected if the column tilts to its maximum where the column bumps into the rim of the central bore 16 in the foot 5.

By untightening the top nut 12 for instance by engagement with the tightening means 2 the column is disengaged so that it can tilt. The top nut 12 has a flange 13 that extends from the lower edge of the inner thread 12 thereof, which has a contact surface 14 that is shaped as a part of a spherical shell and is adapted to come into contact with a corresponding external contact surface that is shaped as a part of a spherical shell on the upper side of the foot around the opening 16 in the foot, where the lower end 6 of the column is lead through this opening 16.

### NUMERALS

1 column
2 tightening device
3 upper end of column
4 bottom nut
5 foot
6 lower end of column
7 upper end of bottom nut
8 set screw
9 contact surface that the bottom nut will touch
10 thread around the lower end of the column
11 internal thread of top nut
12 top nut
13 extending flange of top nut
14 contact surface of top nut
15 contact surface on the upper side of the foot
16 opening in the foot
17 through threaded bore of the bottom nut
18 lower end of the bottom nut
19 seals
20 domed part
21 flange
22 upper side of flange
23 lower side of flange
24 outer rim of flange
25 through openings in flange
26 tightening means
27 thread in the upper end of the column
28 seals between nuts and the flange

1. Levelling apparatus comprising a column which can be mounted in a machine at an upper end and which is releasably mounted in a foot at a lower end, said levelling apparatus further being provided with a top nut that by tightening can lock the position of the column in relation to the foot, where the lower end of said column is inserted into the foot and fastened thereto by tightening of a bottom nut whose upper end has a shape that is complementary to the contact surface of the foot that the bottom nut will touch by tightening, wherein a thread around the lower end of the column is lead up over the foot, said thread being coupled to top nut with internal thread, which top nut has a flange that extends out from the lower edge of its internal thread, said flange having a contact surface that is shaped as a part of a spherical shell and is adapted to come into contact with a corresponding external contact surface that is shaped as a part of a spherical shell on the upper side of the foot around an opening in the foot, where the lower end of the column is lead through this opening.

2. Levelling apparatus according to claim 1, wherein the upper end of the bottom nut is shaped as a part of a spherical shell.

3. Levelling apparatus according to claim 2, wherein the bottom nut is provided with a through threaded bore.

4. Levelling apparatus according to claim 1, wherein the lower end of the bottom nut is flat.

5. Levelling apparatus according to claim 1, wherein the bottom nut is provided with fastening means for mounting of the bottom nut and for fastening thereof by means of a set screw.

6. Levelling means according to claim 1, wherein there is a domed part around the opening in the foot, through which opening the column is lead down into the foot, which domed part is designed to enclose the bottom nut, and that the domed part is enclosed by a flange with an upper side and a lower side and an outer rim, said lower side extending along a plane, where this plane stays uninterrupted by the bottom nut and the column regardless of the angular position of the column in relation to the foot, and that there, furthermore, in the flange are provided through openings between the upper side and the lower side in the area between the external rim and the domed part for mounting of the foot onto a subsurface.

7. Use of the levelling apparatus according to claim 1 in areas with risk of violent vibrations including areas with high risk of earthquakes.

8. Levelling apparatus according to claim 2, wherein the lower end of the bottom nut is flat.

9. Levelling apparatus according to claim 3, wherein the lower end of the bottom nut is flat.

10. Levelling apparatus according to claim 2, wherein the bottom nut is provided with fastening means for mounting of the bottom nut and for fastening thereof by means of a set screw.

11. Levelling apparatus according to claim 3, wherein the bottom nut is provided with fastening means for mounting of the bottom nut and for fastening thereof by means of a set screw.

12. Levelling apparatus according to claim 4, wherein the bottom nut is provided with fastening means for mounting of the bottom nut and for fastening thereof by means of a set screw.

13. Levelling means according to claim 2, wherein there is a domed part around the opening in the foot, through which opening the column is lead down into the foot, which domed part is designed to enclose the bottom nut, and that the domed part is enclosed by a flange with an upper side and a lower side and an outer rim, said lower side extending along a plane, where this plane stays uninterrupted by the bottom nut and the column regardless of the angular position of the column in relation to the foot, and that there, furthermore, in the flange are provided through openings between the upper side and the lower side in the area between the external rim and the domed part for mounting of the foot onto a subsurface.

14. Levelling means according to claim 3, wherein there is a domed part around the opening in the foot, through which opening the column is lead down into the foot, which domed part is designed to enclose the bottom nut, and that the domed part is enclosed by a flange with an upper side and a lower side and an outer rim, said lower side extending along a plane, where this plane stays uninterrupted by the bottom nut and the column regardless of the angular position of the column in relation to the foot, and that there, furthermore, in the flange are provided through openings between the upper side and the lower side in the area between the external rim and the domed part for mounting of the foot onto a subsurface.

15. Levelling means according to claim 4, wherein there is a domed part around the opening in the foot, through which opening the column is lead down into the foot, which domed part is designed to enclose the bottom nut, and that the domed part is enclosed by a flange with an upper side and a lower side and an outer rim, said lower side extending along a plane, where this plane stays uninterrupted by the bottom nut and the column regardless of the angular position of the column in relation to the foot, and that there, furthermore, in the flange are provided through openings between the upper side and the lower side in the area between the external rim and the domed part for mounting of the foot onto a subsurface.

16. Levelling means according to claim 5, wherein there is a domed part around the opening in the foot, through which opening the column is lead down into the foot, which domed part is designed to enclose the bottom nut, and that the domed part is enclosed by a flange with an upper side and a lower side and an outer rim, said lower side extending along a plane, where this plane stays uninterrupted by the bottom nut and the column regardless of the angular position of the column in relation to the foot, and that there, furthermore, in the flange are provided through openings between the upper side and the lower side in the area between the external rim and the domed part for mounting of the foot onto a subsurface.

17. Use of the levelling apparatus according to claim 2 in areas with risk of violent vibrations including areas with high risk of earthquakes.

18. Use of the levelling apparatus according to claim 3 in areas with risk of violent vibrations including areas with high risk of earthquakes.

19. Use of the levelling apparatus according to claim 4 in areas with risk of violent vibrations including areas with high risk of earthquakes.

20. Use of the levelling apparatus according to claim 5 in areas with risk of violent vibrations including areas with high risk of earthquakes.
